(19) United States
(12) Patent Application Publication
(10) Pub. No.: US 2012/0285072 A1
(43) Pub. Date: Nov. 15, 2012

(54) Two in one, vibrating metal jig fishing lure (a.k.a. "Sonic Kandlefish").

(76) Inventor: Peter John Rosko, Naples, FL (US)

(21) Appl. No.: 13/068,507

(22) Filed: May 13, 2011

(51) Int. Cl. A01K 85/01; A01K 83/00; A01K 85/00

(52) U.S. Cl. 43/42.31; 43/43.1; 43/43.16

(57) ABSTRACT

All traditional metal jigs (aka “jigging spoons”) have their lines attached to a metal insert positioned in the nose portion. The invention is a first time radical industry departure by including two primary dynamic functional attachment points in a single metal jig. It is a “2 in 1” hybrid lure with combined blade bait and metal jig actions. The invention is easily converted to a multiplicity of lure actions simply by changing its line and hook attachments from the nose insert to the dorsal insert positioned at its critical balance point on the top of its back. The resultant unmatched hydrosonic vibration, versatility and life-like natural appearance enable the invention to be effectively fished in all fresh and salt waters, worldwide.

### CROSS REFERENCES TO RELATED APPLICATIONS

### Field of Search:

U.S. Class/Sub-Class: 42.33; 42.34; 42.45; 42.46; 42.48; 42.49; 42.51; 42.52; 43/42.32; 43/42.50; 43/42.51

International Class: A01K 85/00/04/12/14

### References Cited:

### U.S. Patent Documents:

U.S. Pat. No. 1,875,122 . . . 8/1932 Olson . . . 43/42.5

U.S. Pat. No. 2,593,027 . . . 5/1949 Heino . . . 43/42.5

U.S. Pat. No. 2,480,580 . . . 8/1949 Hopkins . . . 43/42.5

U.S Pat. No. 2,484,747 . . . 10/1949 Russell . . . 43/42.5

U.S. Pat. No. 2,511,002 . . . 6/1950 Perry . . . 43/42.5

U.S. Pat. No. 2,632,277 . . . 3/1953 Cogswell . . . 43/42.49

U.S. Pat. No. 2,657,495 . . . 11/1953 Eppinger . . . 43/42.5

U.S. Pat. No. 2,809,462 . .. 5/1954 Wallis . . . 43/42.5

U.S. Pat. No. 2,717,468 . . . 9/1955 Clough . . . 43/42.51

U.S. Pat. No. 3,094,804 . . . 6/1963 Walton . . . 43/42.5

U.S. Pat. No. 3,169,337 . . . 8/1963 McGregor . . . 43/42.5

U.S. Pat. No. 3,497,986 . . . 3/1968 Bianco . . . 43/42.5

U.S. Pat. No. 3,896,580 . . . 7/1975 Williams . . . 43/42.5

U.S. Pat. No. 4,155,192 . . . 5/1979 Varaney . . . 43/42.5

U.S. Pat. No. 4,574,514 . . . 3/1986 Kingston . . . 43/42.5

U.S. Pat. No. 4,631,854 . . . 12/1986 Rosko . . . 43/42.34

U.S. Pat. No. 4,700,503 . . . 10/1987 Pippert . . . 43/42.5

U.S. Pat. No. 4,891,900 . . . 1/1990 Snyder . . . 43/42.5

U.S. Pat. No. 5,133,146 . . . 7/1992 Stecher . . . 43/42.5

### FOREIGN PATENT DOCUMENTS

2003-325079; 2003-339277; 2004-16156; 2004-57099; 2004-73148; 2005-73664; WO-86/00499

### BACKGROUND OF THE INVENTION

The invention relates to fishing lures. There is a vast variety of sizes, styles and types of fishing lures including blade baits and metal jigs.

A blade bait consists of two sections, a cast lead alloy forward portion molded around a stamped metal blade portion. The line is attached to a dorsal (top of back) hole in the blade denoting the center balance point. A variety of accessory holes in the blade portion are designed to accommodate the attachment of hooks. Basically, the anatomy is best left to one's imagination. Maximum action is attained on the lift as the lure is being jigged in a vertical up and down motion. The action is a tight side-to-side movement similar to the reciprocal action of a windshield wiper. On the drop, there is minimal fish-attracting action. Sizes generally range between ¼ to ¾ oz.

A metal jig (“a.k.a. jigging spoon”) has only a single section which consists of a cast lead, or non-lead, alloy elongated body with a nose and tail metal insert. The line is attached to the nose portion insert and the hook to the tail portion insert. The anatomy varies between that of a non-descript metal bar to a detailed duplication of a baitfish. Maximum action is attained on the drop as the lure is being vertically jigged. Essentially, gravity sets the lure in motion. The primary action is an erratic flutter. On the lift, there is a swimming motion that attracts but it is the downward darting-fluttering action that results in almost all strikes.

The basis for the invention is to maximize the fish-attracting hydrosonic vibration of a metal jig (“jigging spoon”) on the lift and drop. By combining the actions of a blade bait lure, and a metal jig lure, the action of the invention is dramatically increased. Furthermore, the resultant vibration exceeds that of all other lure types available in the industry.

The invention's 2 in 1 application denotes its industry-leading versatility with the option of the line attachment. Line attachment to the dorsal insert results in maximum hydrosonic vibration primarily when vertical jigging. Line attachment to the nose, and even to the tail, insert results in the flutter action of a traditional metal jig enabling it to be cast, trolled or vertically/horizontally jigged .

### BRIEF SUMMARY OF THE INVENTION

Historically, all metal jigs are attached to a fishing line at their nose. By adding an innovative second attachment to the dorsal balance point on a metal jig (the invention), this most versatile lure type is further-enhanced in its ability to maximize its hydrosonic vibration, and action, while vertical jigging.

### DESCRIPTION OF THE DRAWINGS

FIG. 1 is a side view of a blade bait.

FIG. 2 is a side view of a metal jig (the original Kandlefish).

FIG. 3 is a side view of the invention (a.k.a. Sonic Kandlefish), resulting from the merger of the lures in FIGS. 1 and 2. An optional insert is also shown at the ventral (belly) balance point for an accessory hook attachment.

FIG. 4 is a view looking down on the entire length of the dorsal portion of the invention. The dorsal insert is replaced with an optional hole extending through the ventral portion of the body at its balance point. This results in a “line-thru-body” concept in which there is no lure body weight attached to the hook. By eliminating weight on the hook, torque is lessened from a fighting fish and hook dislodgement is minimized.

FIG. 5 is a cross section view showing the rear portion of the invention.

### DETAILED DESCRIPTION OF THE DRAWINGS

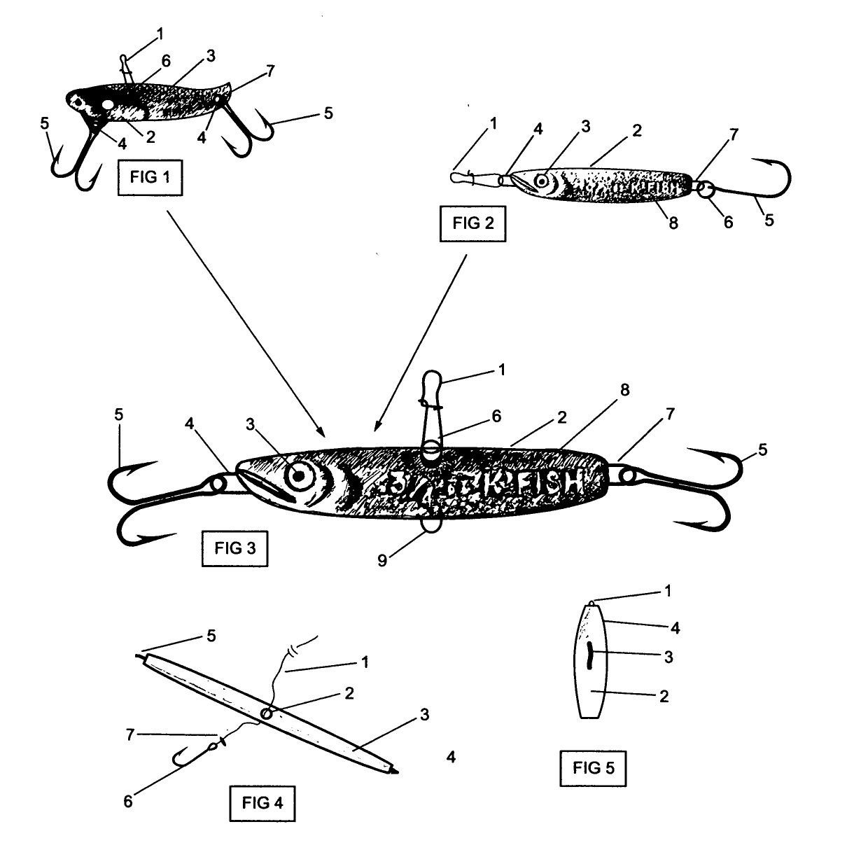

FIG. 1:
1) Stainless steel duolock snap attached to the dorsal insert on the stamped metal blade.
2) Cast lead alloy body in which a thin stamped metal blade is imbedded.
3) Thin stamped metal (brass) blade with a smooth surface.
4) Accessory holes for hook attachments on the stamped metal blade.
5) Hooks.
6) Dorsal hole (balance point) on the stamped metal blade.
7) Tail section

FIG. 2:
1) Stainless steel duolock snap attached to the nose insert on the Kandlefish metal jig.
2) Cast lead alloy body of the metal jig with a hammered surface.
3) 3-D prism eye to accentuate the realistic appearance of a candlefish baitfish.
4) Stainless steel nose insert.
5) Hook.
6) Stainless steel split ring connecting the hook to the stainless steel tail insert.
7) Stainless steel tail insert
8) Weight and name description of the Kandlefish metal jig.

FIG. 3:
1) Stainless steel duolock snap.
2) Cast lead alloy body on the invention with a hammered surface.
3) 3-D prism eye to accentuate the realistic appearance of a candlefish baitfish.
4) Stainless steel nose insert.
5) Hooks.
6) Dorsal stainless steel insert at the balance point.
7) Stainless steel tail insert.
8) Weight and name description of the invention.
9) Optional stainless steel insert, at the ventral (belly) balance point, for a hook attachment.

FIG. 4:
1) “Line-thru-body”.
2) Dorsal opening.
3) Cast lead alloy body with a hammered surface.
4) Stainless steel tail insert.
5) Stainless steel nose insert.
6) Hook attached to line.
7) Rubber bumper to prevent damage to the hook knot during vertical jigging.

FIG. 5:
1) Stainless steel dorsal insert.
2) Cast lead alloy body.
3) Stainless steel tail insert.
4) Hammered surface.

### DETAILED DESCRIPTION OF THE INVENTION

The invention is the first true metal jig to incorporate a line attachment on the top of its back (dorsal), positioned at its balance point. It is a “2 in 1” hybrid lure with combined blade bait and metal jig actions. Dorsal and nose line attachments, on the same metal jig, requires precise balance for each type of action (blade bait and metal jig) to perform with consistent efficacy.

With the dorsal line attachment, the invention has unsurpassed high frequency hydrosonic vibration on both the lift and fall. On the lift, the action is exclusively a tight, side-to-side vibration similar to a reciprocal, fast-moving windshield wiper. On the fall, gravity initially causes the same side-to-side vibration then that movement transforms to the darting-gliding-fluttering action of a metal jig.

To change the hybrid action from the “Sonic Kandlefish” (dorsal) to the original metal jig “Kandlefish” (nose), simply remove the nose hook and reposition the line attachment from its dorsal position to the nose insert. The nose, and tail, attachments excel at a lively darting fluttering action on the fall without any need for rod exertion (jerking). Besides vertical jigging, the nose attachment's versatility effectively includes trolling, casting and horizontal jigging.

Because of its “2 in 1” concept, it is not necessary to carry a tackle box loaded with a multiplicity of different lures. Vibration and flutter comprise almost 100% of fish-attracting actions in both fresh and salt water. These are the hallmarks of the invention. The dorsal line attachment excels in emitting maximum vibration on the lift and fall. In conclusion, it's the dorsal insert on a metal jig (the invention) that distinguishes its functional value over all other metal jigs and for which primary patent protection is being requested.
Presently, there is no other lure type that has the natural appearance, versatility and fish-attracting hydrosonic action than the invention.

What I claim as my inventions are:

1. A dorsal metal insert which is placed at a critical balance point, in a conventional metal jig, to which line is attached to achieve maximum hydrosonic vibration when vertical jigging.

2. A dorsal opening which is placed at a critical balance point, in a conventional metal jig, with an exit hole at its corresponding ventral (belly) balance point. Line is passed from the dorsal opening, through the lure and out of the ventral exit to which a hook is attached.

3. An optional ventral metal insert, placed at the balance point, to function as a hook attachment for vertical jigging applications.
